(19) United States
(12) Patent Application Publication
(10) Pub. No.: US 2007/0241036 A1
(43) Pub. Date: Oct. 18, 2007

(54) Filter for filtering fuel

(75) Inventors: Dieter Amesoeder, Bietigheim-Bissingen (DE); Dieter Schreckenberger, Marbach (DE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GMBH, Ludwigsburg (DE)

(21) Appl. No.: 11/802,407

(22) Filed: May 22, 2007

Related U.S. Application Data
(63) Continuation of application No. PCT/EP05/55855, filed on Nov. 9, 2005.

(30) Foreign Application Priority Data
Nov. 22, 2004 (DE) 10 2004 056 366.7

(51) Int. Cl. B01D 35/14

(52) U.S. Cl. 210/90; 210/86; 210/97; 210/243; 210/330; 210/486

(57) ABSTRACT

A liquid filter (1) for filtering fuel or another liquid, including a filter element (9) disposed in a housing (2) and having at least one end cap (3, 4) formed by a section of the housing (2). The filter element (9) is embedded in the end cap (3, 4) or is at least joined to the end cap in an electrically conductive manner. The end cap (3, 4) is composed of an electrically conductive synthetic resin material, and an electric contact (14) for conducting away an electric charge is provided on the housing (2), preferably on the end cap (3, 4).

### CROSS REFERENCE TO RELATED APPLICATIONS

This application is a continuation of international patent application no. PCT/EP2005/055855, filed Nov. 9, 2005 designating the United States of America, the entire disclosure of which is incorporated herein by reference. Priority is claimed based on Federal Republic of Germany utility model application no. DE 10 2004 056 366.7, filed Nov. 22, 2004.

### BACKGROUND OF THE INVENTION

The invention relates to a filter, particularly for filtering fuel, having a filter element arranged in a housing with at least one end disk formed by a section of the housing, such that the filter element is embedded into the end disk or is at least electrically conductively connected to the end disk.

A filter with a filter element arranged in a housing is known from United States Patent Application No. 2003/0057146 A1. This filter element is cylindrical and is closed at its ends by means of two spaced apart end disks. One of the two end disks is an electrically non-conductive housing cover formed of synthetic resin material (i.e., plastic), and the filter element is embedded into this synthetic resin housing cover formed by the end disk. The end disk opposite the end disk formed by the housing cover is made of metal. Between the metal end disk and the housing is an electrically conductive spring member, which electrically conductively connects the metal end disk to an electric contact pin disposed on the end face of the electrically non-conductive housing. The electric contact pin serves to discharge an electrical charge from the filter element through the metal end disk and the electrically conductive spring member. Because of the complicated installation of the spring member, assembly of the prior art filter is highly complex. Furthermore, the known filter includes many metal parts, so that its production is comparatively costly.

The German publication DE 101 38 073 A1 discloses a filter with a filter element, in which the filter element is disposed in a metal housing. The filter element is provided with two spaced-apart end disks formed of an electrically conductive synthetic resin material, such that one end disk contacts a metal housing cover. This electrically conductive connection causes an electrical charge of the filter element to be discharged through the metal housing cover. A drawback in this prior art filter is its relatively high weight, which is due to the metal construction of the housing.

### SUMMARY OF THE INVENTION

It is an object of the invention to provide an improved fuel filter able to discharge electrical charges.

Another object of the invention is to provide a fuel filter which has a minimum number of components and is simple to assemble.

A further object of the invention is to provide a fuel filter which is light weight and is cost effective to manufacture and install.

These and other objects are achieved in accordance with the present invention by providing a liquid filter comprising a filter element disposed inside a housing, the filter element comprising a filter material connected to at least one end disk, and the at least one end disk being formed by a section of the housing, wherein the at least one end disk is formed of an electrically conductive synthetic resin material, and an electrical contact is provided on the housing for conducting an electrical charge away from the filter element.

Advantageous variants and preferred embodiments of the invention are described in further detail hereinafter.

The concept underlying the invention is to make the end disk, which is integrally formed with a housing section, electrically conductive, so that an electrical charge of the filter element, particularly a paper and/or nonwoven element, can be discharged through this end disk, which is integrally formed with a housing part. The discharge of the electrical charge is ensured by the conductive configuration of the end disk, which is made of synthetic resin material (i.e., plastic). Forming the end disk of synthetic resin material also reduces the weight of the component.

To enable the electrical charge to be discharged by the end disk, an electrical contact is provided. This electrical contact is electrically conductively connected to the battery, the vehicle body or a component connected to the vehicle body. If at least one end disk is integrally configured with a housing section, a separate end disk is no longer necessary, so that the number of the components required is reduced. The number of the required components is further reduced because the electrically conductive configuration of the end disk formed integrally with a housing part makes it unnecessary to provide special contacting means, such as metal springs.

Forming the end disk of electrically conductive synthetic resin material as an integral part of the housing makes it possible to embed the filter element into the end disk, e.g., by partly melting the end disk. A static charge of the filter element is therefore discharged directly to the end disk and from there to the electrical contact. It is conceivable to use a fastening screw for the fixation of the filter as the electrical contact.

A further embodiment of the invention provides that the end disk be formed by a housing cover, which is releasably or non-releasably connected to a circumferential wall of the housing. The configuration of the end disk as a housing cover has the advantage that the filter element can be embedded into the housing in a first process step, e.g., by partially melting the housing cover. The unit consisting of the housing cover and the filter element can then be connected to the rest of the housing in a second process step. The housing cover is preferably releasably connected to the rest of the housing, so that the filter element can be replaced together with the housing cover.

In accordance with a first alternative embodiment of the invention, the electrical contact is a contact pin, particularly made of metal. The contact pin is preferably embedded into the end disk material or is held to or by the end disk material. The contact pin is electrically conductively connected to the vehicle body, particularly via a cable.

In accordance with a second alternative embodiment of the invention, the electrical contact is formed by a functional component of the filter. In particular, it is conceivable to use a pressure regulator, a pressure sensor or a level indicator as an electrical contact for discharging an electrical charge. Thus, the corresponding functional component has a dual function: its original function on the one hand and its additional function as an electrical contact for discharging an electrical charge on the other. The advantage of this embodiment of the invention is that a separate contact pin, e.g., formed of metal, is no longer necessary. This variant also reduces the number of cables required.

The conductivity of the synthetic resin material is advantageously achieved by doping the synthetic resin material with electrically conductive materials, particularly carbon fibers. Doping with electrically conductive materials makes synthetic resin materials, such as acetal, nylon or polyethylene, conductive. The amount of the added electrically conductive materials is proportional to the conductivity of the end product.

It is advantageous to use a pleated, preferably cylindrical filter element. As a rule, the medium to be filtered flows radially from the outside through the pleated filter element into a discharge channel disposed in the center. The pleated configuration of the filter element increases the effective filter surface. The filter element essentially consists of a filter paper or a filter nonwoven and usually includes a rigid support structure, particularly one made of synthetic resin material.

In accordance with a further refinement of the invention, the filter element has two end disks, both of which are formed by a housing part, particularly by a housing cover. It is conceivable to make both end disks of an electrically conductive synthetic resin material and mount an electrical contact on each for discharging an electrical charge.

In another embodiment of the invention, the housing has two spaced apart housing covers and a circumferential wall connecting these housing covers to one another, and the two covers are electrically conductively interconnected, preferably by this circumferential wall. This embodiment of the invention requires only a single contact on the entire housing, through which can be discharged not only the electrical charge of the filter element but also that of the housing.

Preferably, a plurality of the housing parts, especially all the housing parts, are formed of an electrically conductive synthetic resin material. This reduces the overall weight of the filter and simultaneously optimizes discharge of electrical charges.

### BRIEF DESCRIPTION OF THE DRAWINGS

The invention will be described in further detail hereinafter with reference to illustrative preferred embodiments shown in the accompanying drawing figures, in which:

FIG. 1 is a perspective view of a filter constructed according to the present invention;

FIG. 2 is a sectional view of the filter shown in FIG. 1;

FIG. 3 is another sectional view of the filter of FIG. 1 but rotated in relation to the view of FIG. 2, and

FIG. 4 is a sectional view of an alternative filter embodiment in accordance with the present invention.

### DETAILED DESCRIPTION OF PREFERRED EMBODIMENTS

In the figures, like components and components having the same function are identified by the same reference numerals.

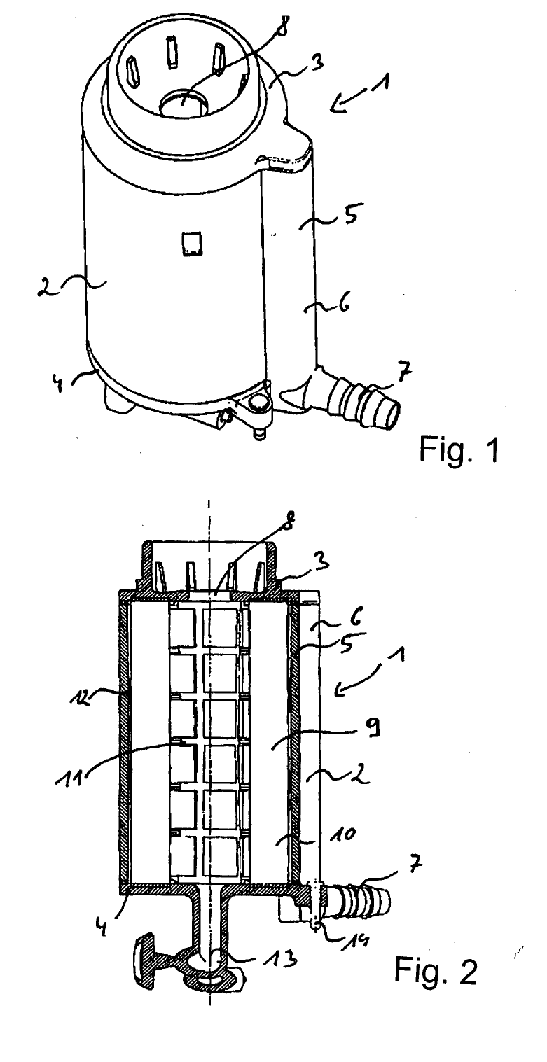

FIG. 1 is a perspective view of the filter 1. It essentially shows the circular cylindrical housing 2 with two spaced apart housing covers 3, 4. The two housing covers 3, 4 are interconnected by a circumferential wall 5. An intake line 7 for fuel opens into an outwardly curved portion 6 of the circumferential wall. The fuel leaves the filter 1 through a central opening 8 formed in the upper housing cover 3, as seen in the drawing plane.

FIG. 2 is a sectional view of the filter 1 showing the filter element 9 disposed within the housing 2. The filter element 9 is formed of a pleated, hollow cylindrical filter paper 10, which is stabilized and held by a central synthetic resin material support structure 11.

A liquid channel is formed within the support structure 11 in the center of the housing 2. This channel communicates with the outlet opening 8 formed in the housing cover 3, so that fuel can flow through the inlet opening 7 into an annular chamber or space 12 radially outside of the filter paper 10 and then radially inwardly through the filter paper 10 into the channel enclosed by the support structure 11 before flowing out of the housing 2 through the opening 8. A portion of the fuel can flow back through an outlet channel 13 disposed at the bottom, as seen in the drawing plane, into the tank volume of the motor vehicle.

The two housing covers 3, 4 form end disks for the pleated filter element and are connected to the filter paper 10 of the filter element in a liquid tight manner, so that no liquid can pass between the filter paper and the end disk. More precisely, the filter element 9, or the filter paper 10, is embedded into the two housing covers 3, 4. From an assembly standpoint, this is accomplished, for example, by partially melting the housing covers in the contact region. Both housing covers 3, 4 are formed of electrically conductive synthetic resin material doped with carbon fibers. The circumferential wall 5 is also formed of this electrically conductive material.

Preferably the housing is comprised at least 50% of electrically conductive synthetic resin material. Particularly preferably, the housing is comprised substantially entirely of electrically conductive material.

Outside of the circumferential wall 5, an electrical contact pin 14 is inserted into the electrically conductive housing cover 4. This pin may be connected to the vehicle chassis or body, for example. An electrical charge of the filter element 9 can be discharged through the end disk configured as the housing cover 4 and the contact pin 14. Since both the upper housing cover 3 and the circumferential wall 5 are formed of electrically conductive synthetic resin material, the entire housing 2 of the filter 1 can be grounded through the contact pin 14. No additional contact connections are necessary.

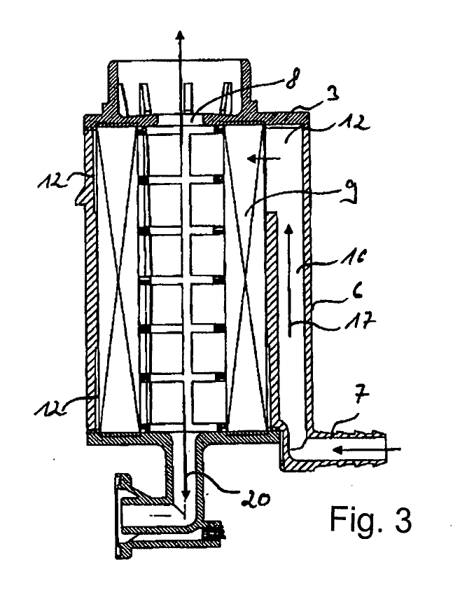

FIG. 3 indicates the flow of the fuel by means of arrows. The fuel flows through the intake line 7 (arrow 15) and through a flow channel 16 formed within an outwardly curved portion 6 (arrow 17) into the annular space 12 surrounding the filter element 9. From there it flows through the filter element 9 (arrow 18) before reaching the channel enclosed by the filter element 9. From there, a portion of the fluid flows out through the opening 8 in the housing cover 3 toward the engine (arrow 19). Another portion of the fuel flows in opposite direction back into the tank of the motor vehicle (arrow 20).

The contact pin 14 is not shown in the illustration of FIG. 3 because of the location of the section. In place of the contact pin 14, which is electrically conductively connected to the housing cover 4 configured as an end disk, functional components of the filter 1 may also be used for discharging electrical charges.

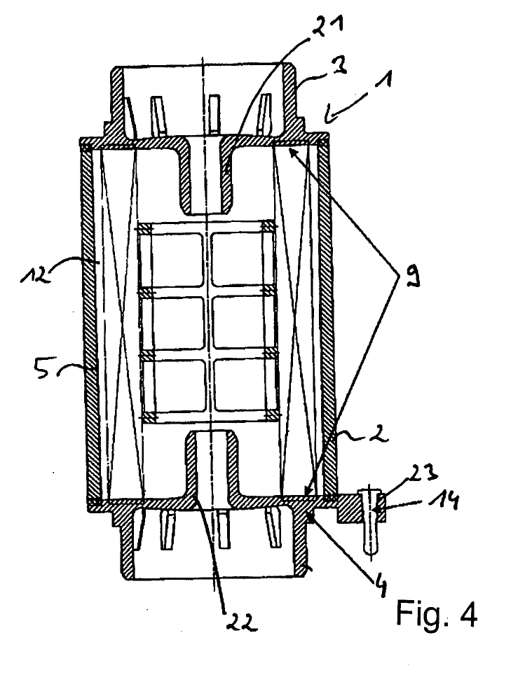

FIG. 4 illustrates an alternative embodiment of a filter 1. In this embodiment, the housing covers 3, 4 formed of an electrically conductive synthetic resin material are provided with fittings 21, 22, which protrude into the channel formed within the filter element 9. The intake line to the annular chamber 12 within the housing 2 is not shown. Through the upper fitting 21, as seen in the drawing plane, the fuel flows out of the filter 1 toward the engine. Through the lower fitting 22, as seen in the drawing plane, the fuel flows back into the tank of the motor vehicle. In the embodiment illustrated here, the housing covers 3, 4 again form end disks for the filter element 9. The housing cover 4 is provided with a metallic contact pin 14, which is held in an opening 23 of the housing cover 4.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. A liquid filter comprising a filter element disposed inside a housing, said filter element comprising a filter material connected to at least one end disk, and said at least one end disk being formed by a section of the housing, wherein the at least one end disk is formed of an electrically conductive synthetic resin material, and an electrical contact is provided on the housing for conducting an electrical charge away from the filter element.

2. A filter as claimed in claim 1, wherein the electrical contact is provided on the end disk.

3. A filter as claimed in claim 1, wherein the end disk is formed by a housing cover which is connected to a circumferential wall of the housing.

4. A filter as claimed in claim 3, wherein the housing cover is releasably connected to the circumferential wall of the housing.

5. A filter as claimed in claim 1, wherein the electrical contact (14) is a conductive contact pin.

6. A filter as claimed in claim 5, wherein the contact pin is made of metal.

7. A filter as claimed in claim 1, characterized in that the electrical contact is a functional component of the filter.

8. A filter as claimed in claim 7, wherein said functional component is a pressure regulator, a pressure sensor or a fill-level indicator.

9. A filter as claimed in claim 1, wherein the conductivity of the synthetic resin material is obtained by doping the synthetic resin material with electrically conductive material.

10. A filter as claimed in claim 9, wherein the synthetic resin material is doped with electrically conductive carbon fibers.

11. A filter as claimed in claim 1, wherein the filter material comprises filter paper or a nonwoven filter web or both a filter paper and a nonwoven filter web.

12. A filter as claimed in claim 1, wherein the filter material has a pleated cylindrical form.

13. A filter as claimed in claim 1, wherein the filter element comprises two end disks each formed by a part of the housing.

14. A filter as claimed in claim 13, wherein the two end disks are each formed by a housing cover.

15. A filter as claimed in claim 1, wherein the housing comprises two spaced apart housing covers and a circumferential wall connecting the two housing covers with one another, and wherein the two housing covers are electrically conductively connected to one another.

16. A filter as claimed in claim 15, wherein the two housing covers are electrically conductively connected to one another by the circumferential wall.

17. A filter as claimed in claim 1, wherein the housing is comprised at least 50% of electrically conductive synthetic resin material.

18. A filter as claimed in claim 17, wherein the housing is comprised substantially entirely of electrically conductive material.

19. A filter according to claim 1, wherein said filter is a fuel filter for an internal combustion engine.
